(19) United States
(12) Patent Application Publication
(10) Pub. No.: US 2014/0145507 A1
(43) Pub. Date: May 29, 2014

(54) Emergency Cell Charger

(71) Applicant: Ralph John Iervolino, Santa Rosa, CA (US)

(72) Inventor: Ralph John Iervolino, Santa Rosa, CA (US)

(21) Appl. No.: 13/684,502

(22) Filed: Nov. 24, 2012

(51) Int. Cl. H02J 7/00; H02J 9/00

(52) U.S. Cl. CPC H02J 7/0055; H02J 9/00
USPC 307/66

(57) ABSTRACT

This invention teaches an emergency charging device for cell telephones. When the electrical power is not available in a city, the person who has been depending on mass transportation system, who does not own an automobile, uses this device to recharge cell telephones. This emergency cell telephone charging device allows recharging the cell telephone and allows continued communication with the world during times when electrical power is not available.

### BACKGROUND OF THE INVENTION

1. Field of the Invention

This invention is a device to allow cell telephones to be charged when other sources of electrical power for charging are not available.

2. Description of the Prior Art

U.S. Pat. No. 6,977,479 which teaches PORTABLE CELL PHONE BATTERY CHARGER USING SOLAR ENERGY AS A PRIMARY SOURCE OF POWER which was issued to Po-Jung (John) Hsu on Dec. 20, 2005 uses solar cells to charge cell telephones. Using solar cells to charge cell telephones is great in the Sun Belt states, but in many regions the sun rarely shines for much of the year. In the event of a power outage in such regions this charger would not provide an ability to recharge and use cell telephones.

Chia-Yao Chnag was issued a U.S. Pat. No. 5,687,234 on Nov. 11, 1997 which teaches MOBILE TELEPHONE CHARGER. MOBILE TELEPHONE CHARGER is useful when automobile or wall sockets are available, but in the event of a power outage in a city with no automobile availability the MOBILE TELEPHONE CHARGER does not have sufficient battery capacity to provide the charging need to keep mobile telephones available for communication in time of crises.

### SUMMARY OF THE INVENTION

The EMERGENCY CELL CHARGER provides from one to eight or more amp hours of cell or mobile telephone charging in the event of a power outage by incorporating a vehicle size battery as part of the design that will provide from one to eight or more amp hours of service. The EMERGENCY CELL CHARGER incorporates a computer chip microprocessor that manages the incorporated battery to assure that the eight or more amp hours of service is available when line power is off. For city dwellers who depend on mass transit who do not have an automobile, the emergency cell charger provides the power source for maintaining cell or mobile telephones in the charged and usable condition during power outages.

### BRIEF DESCRIPTION OF THE DRAWINGS

FIG. 1 shows the component parts of the EMERGENCY CELL CHARGER.

### BEST MODE FOR CARRYING OUT THE INVENTION

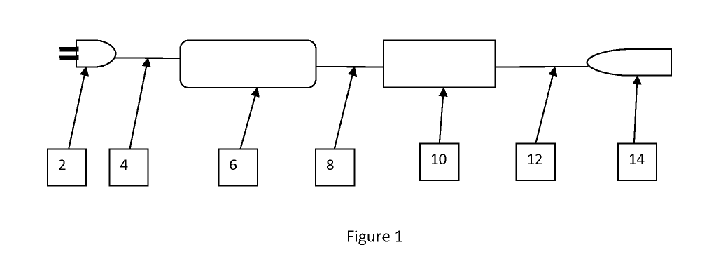

This description of the invention will be referring to the drawing provided. In FIG. 1, pronged oval 2 is a plug for bringing power from a wall outlet into the device. Pronged oval 2 is here pictured with two prongs, but alternative embodiments could have more prongs to adapt to the wall out lets in various countries. Line 4 in FIG. 1 is an electrical supply cable to bring electrical power from pronged oval 2 into the EMERGENCY CELL CHARGER.

Rounded corner rectangle 6 is a battery managing device such as is sold by Deltran Corporation of 801 International Speedway Boulevard, Deland, Fla. Deltran Corporation makes a device called the Battery Tender® Junior which provides charging management for a 12 volt battery has a microprocessor that manages the way a battery is charged in four different modes. These four modes are initialization, bulk charge, absorption mode, and float mode. A device like this that is sold by Deltran Corporation will maintain the battery at top charge until the device is unplugged or the power fails. At the time that the power fails a device like this no longer hinders the battery that was being managed. When the power fails the battery becomes available to charge cell and mobile telephones.

Line 8 is a cable connecting the output of the rounded corner rectangle 6 to rectangle 10 which is the battery that provides the power for recharging cell and mobile telephones. Line 8 will usually be a double conductor cable to provide connection to both poles of the battery depicted by rectangle 10 in the drawing. In the preferred embodiment of this invention rectangle 10 will be a battery that is designed to deliver 8 amp hours or more of electrical service.

The Universal Power Group of 1720 Haydon Drive, Carrollton, Tex. provides such a battery under part number UB1280.

Line 12 is a cable connecting the output of the battery seen in the drawing as rectangle 10 to truncated oval 14 which is a female cigarette lighter adapter provided for connecting the male cigarette lighter adapter associated with the cell and mobile telephones that need to be charged. Deltran Corporation sells one under part number 081-0069-8.

What I claim as my invention is:

1. A device for charging up a cell telephone when cars and electrical power are not available comprised of an electrical cord that connects to a house wall socket a battery manager a storage battery and a female car cigarette lighter adapter for connecting to the cell telephones male cigarette lighter adaptor.

2. A method for keeping a cell telephone functioning when the battery of the cell telephone has lost its charge.

3. A device for charging up a cell telephone as is claimed in claim 1 where the device keeps a charge for the cell telephone when the power that maintains it is gone.

4. A method for charging up a cell telephone as is claimed in claim 2 where the device keeps a charge for the cell telephone when the power that maintains the battery of the device is gone.

5. A device as is claimed in claim 1 with a storage battery that is rated for 8 amp hours of energy.

6. A device as is claimed in claim 1 with a storage battery that will provide more than an hour of charging energy.
